(19) United States
(12) Patent Application Publication
(10) Pub. No.: US 2026/0181591 A1
(43) Pub. Date: Jun. 25, 2026

(54) SEARCH SPACE CONFIGURATION METHOD AND APPARATUS, SEARCH SPACE DETERMINATION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 18/727,411

(22) PCT Filed: Jan. 10, 2022
(86) PCT No.: PCT/CN2022/071130

§ 371 Date: Jul. 9, 2024

(51) Int. Cl. H04W 68/02; H04W 24/10; H04W 72/0446; H04W 72/0457; H04W 72/51

(52) U.S. Cl. CPC H04W 68/02; H04W 24/10; H04W 72/0446; H04W 72/0457; H04W 72/51

(57) ABSTRACT

A method for configuring search space includes: configuring a first search space, for a paging early indication (PEI) of a first type of terminal, in one of a first bandwidth part (BWP) or a second BWP.

### CROSS REFERENCE TO RELATED APPLICATIONS

This application is a National Phase of International Application No. PCT/CN2022/071130, filed on Jan. 10, 2022, the entire contents of which are incorporated herein by reference in their entireties.

### TECHNICAL FIELD

The present disclosure relates to the field of communication technologies, and in particular to a method and apparatus for configuring search space, a method and apparatus for determining search space, a communication device and a computer-readable storage medium.

### BACKGROUND

In related arts, in order to solve the problem of empty monitoring for paging, a paging early indication (PEI) is introduced, and the terminal can determine whether to monitor paging signaling according to the PEI, thus waste of resources is avoided.

The PEI is transmitted through a physical downlink control channel (PDCCH), and the PDCCH corresponding to the PEI is transmitted in a search space (SS) for the PEI. A frequency domain resource of the SS for the PEI is in an initial downlink bandwidth part (initial DL BWP) of the system.

### SUMMARY

According to a first aspect of the embodiments of the present disclosure, there is provided a method for configuring search space, performed by a network-side device, and including: configuring a first search space, for a paging early indication (PEI) of a first type of terminal, in a first bandwidth part (BWP) or in a second BWP.

According to a second aspect of the embodiments of the present disclosure, there is provided a method for determining search space, performed by a first type of terminal, and including: determining a first search space for a paging early indication (PEI) in a first bandwidth part (BWP) or in a second BWP.

According to a third aspect of the embodiments of the present disclosure, there is provided a communication device, including: a processor; and a memory storing computer programs, where the computer programs, when executed by the processor, cause the processor to perform the above-mentioned method for configuring search space.

According to a fourth aspect of the embodiments of the present disclosure, there is provided a communication device, including: a processor; and a memory storing computer programs, where the computer programs, when executed by the processor, cause the processor to perform the above-mentioned method for determining search space.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and a person of ordinary skill in the art may still derive other drawings from these accompanying drawings without inventive efforts.

FIG. 1 is a schematic flowchart illustrating a method for configuring search space according to an embodiment of the present disclosure.

FIG. 2 is a schematic diagram illustrating a paging occasion (PO) according to an embodiment of the present disclosure.

FIG. 3 is a schematic diagram illustrating a PEI according to an embodiment of the present disclosure.

FIG. 4 is a schematic flowchart illustrating a method for configuring search space according to another embodiment of the present disclosure.

FIG. 5 is a schematic flowchart illustrating a method for configuring search space according to yet another embodiment of the present disclosure.

FIG. 6 is a schematic flowchart illustrating a method for configuring search space according to still another embodiment of the present disclosure.

FIG. 7 is a schematic flowchart illustrating a method for configuring search space according to still another embodiment of the present disclosure.

FIG. 8 is a schematic flowchart illustrating a method for determining search space according to an embodiment of the present disclosure.

FIG. 9 is a schematic flowchart illustrating a method for determining search space according to another embodiment of the present disclosure.

FIG. 10 is a schematic flowchart illustrating a method for determining search space according to yet another embodiment of the present disclosure.

FIG. 11 is a schematic flowchart illustrating a method for determining search space according to still another embodiment of the present disclosure.

FIG. 12 is a schematic flowchart illustrating a method for determining search space according to still another embodiment of the present disclosure.

FIG. 13 is a schematic flowchart illustrating a method for determining search space according to still another embodiment of the present disclosure.

FIG. 14 is a schematic flowchart illustrating a method for determining search space according to still another embodiment of the present disclosure.

FIG. 15 is a block diagram illustrating an apparatus for configuring search space according to an embodiment of the present disclosure.

FIG. 16 is a block diagram illustrating an apparatus for determining search space according to an embodiment of the present disclosure.

FIG. 17 is a block diagram illustrating a device for configuring search space according to an embodiment of the present disclosure.

FIG. 18 is a block diagram illustrating a device for determining search space according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

For purposes of brevity and ease of understanding, the wordings “greater than” or “less than”, “higher than” or “lower than” are used herein to characterize size relationships. However, for those skilled in the art, it will be understood that the wording “greater than” covers the meaning of “greater than or equal to”, and the wording “less than” covers the meaning of “less than or equal to”. The wording “higher than” covers the meaning of “higher than or equal to”, and the wording “lower than” covers the meaning of “lower than or equal to”.

In the current system, there is only one SS for the PEI, the one SS for the PEI is shared for all terminals, and the initial DL BWP is the same for all terminals. However, with the development of communication technology, different types of terminals are introduced, and different initial DL BWPs can be configured for the different types of terminals, as a result, it difficult for the terminals to determine within which initial DL BWP the SS for the PEI is located.

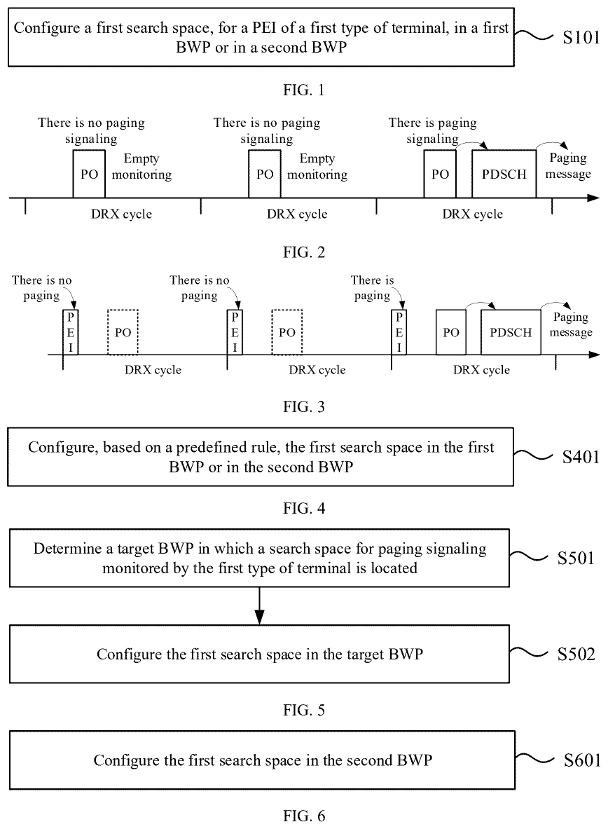

FIG. 1 is a schematic flowchart illustrating a method for configuring search space according to an embodiment of the present disclosure. The method for configuring search space shown in this embodiment can be performed by a network-side device, which can communicate with a terminal. The network-side device includes, but is not limited to, a base station (such as a 4G base station, a 5G base station, a 6G base station and the like) in a communication system. The terminal includes, but is not limited to, a communication device such as a mobile phone, a tablet, a wearable device, a sensor, and an internet of thing (IoT) device.

As shown in FIG. 1, the method for configuring search space may include the following step S101.
At step S101, a first search space for a paging early indication (PEI) of a first type of terminal is configured in a first bandwidth part (BWP) or in a second BWP.

In an embodiment, in a discontinuous reception (DRX) scenario, the terminal can monitor paging signaling transmitted by the network-side device in the paging occasion (PO) in each DRX cycle. However, the network-side device does not necessarily transmit paging signaling in each DRX cycle. When the network-side device does not transmit paging signaling in a DRX cycle, the terminal performs the monitoring in the PO of this DRX cycle, which will result in waste of resources of the terminal.

FIG. 2 is a schematic diagram illustrating a PO according to an embodiment of the present disclosure.

As shown in FIG. 2, illustrated by the example of three DRX cycles, there is a PO in each of the three DRX cycles. In a first DRX cycle and a second DRX cycle, the network-side device does not transmit paging signaling, and in a third DRX cycle, the network-side device transmits paging signaling.

The terminal cannot listen to the paging signaling even if the terminal performs the monitoring in the POs of the first and second DRX cycles. The terminal can listen to the paging signaling when the terminal performs the monitoring in the PO of the third DRX cycle, and thus the terminal can monitor a paging message according to a resource of the paging message carried in the paging signaling. For example, the paging message can be carried in a physical downlink shared channel (PDSCH).

It can be seen that when the terminal performs the monitoring in the POs of the first DRX cycle and the second DRX cycle, the terminal cannot listen to the paging signaling, which results in waste of resources (e.g., power) of the terminal.

To overcome this problem, a PEI can be introduced. For example, a PEI can be provided separately in each DRX cycle, and the network-side device indicates through the PEI whether the paging signaling is transmitted in the DRX cycle in which the PEI is located.

FIG. 3 is a schematic diagram illustrating a PEI according to an embodiment of the present disclosure.

As shown in FIG. 3, for example, based on the embodiment shown in FIG. 2, the network-side device may transmit a PEI in each of the three DRX cycles, where the PEIs in the first DRX cycle and the second DRX cycle may indicate that the network-side device does not transmit paging signaling in the first DRX cycle and the second DRX cycle, and the PEI in the third DRX cycle may indicate that the network-side device transmit paging signaling in the third DRX cycle.

The terminal can determine that the network-side device does not transmit paging signaling according to the PEIs in the first DRX cycle and the second DRX cycle. The terminal can determine that the network-side device transmit paging signaling according to the PEI in the third DRX cycle. Therefore, the terminal does not monitor paging signaling in the POs of the first DRX cycle and the second DRX cycle, and monitors paging signaling in the PO of the third DRX cycle. Accordingly, according to the PEI, the terminal monitors paging signaling only in the PO of the DRX cycle in which the network-side device transmits paging signaling, and does not monitor paging signaling in the PO of the DRX cycle in which the network-side device does not transmit paging signaling, such that waste of resources of the terminal is avoided.

In an embodiment, The PEI is transmitted through a PDCCH, and the PDCCH corresponding to the PEI is transmitted in a search space (SS) for the PEI. A frequency domain resource of the SS for the PEI is in an initial DL BWP of the system. Therefore, to obtain the PEI, the terminal needs to first determine the initial DL BWP in which the SS for the PEI is located, then determine the SS for the PEI in the determined initial DL BWP, and then determine the PEI in the SS for the PEI.

In some systems, there is only one SS for the PEI, the one SS for the PEI is shared for all terminals (for example, all terminals in a cell), and the initial DL BWP is the same for all terminals. However, with the development of communication technology, different types of terminals are introduced, and different initial DL BWPs can be configured for the different types of terminals.

For example, for two types of terminals, the initial DL BWP configured for a first type of terminal is called a first BWP, and the initial DL BWP configured for a second terminal is called a second BWP. The first BWP is different from the second BWP. The presence of two different initial DL BWPs makes it difficult for the terminal to determine within which initial DL BWP the SS for the PEI is located.

For example, based on a legacy user equipment (UE) (also known as non-reduced capability (RedCap) UE), a RedCap terminal, also known as new radio (NR)-lite, have been introduced. For the legacy UE and the RedCap terminal, the configured initial DL BWPs can be the same or different. For example, the initial DL BWP is configured for the legacy UE according to the traditional way, while a separate initial DL BWP is configured for the RedCap terminal. The separate initial DL BWP for the RedCap terminal may be different from the initial DL BWP for the legacy UE. Alternatively, the separate initial DL BWP for the RedCap terminal may be the same as the initial DL BWP for the legacy UE. For the RedCap terminal, it is necessary to determine exactly which initial DL BWP the SS for the PEI is in.

According to the present disclosure, the network-side device can configure the first search space, for the PEI of the first type of terminal, in the first BWP or in the second BWP, such that the first type of terminal can explicitly determine the search space for the PEI in the first BWP or in the second BWP, so as to determine the BWP accurately, and thus can obtain the PEI in the determined search space for the PEI.

In an embodiment, the first type of terminal monitors a paging message on the first BWP.

In an embodiment, the first BWP includes an initial DL BWP for the first type of terminal; and/or the second BWP includes an initial DL BWP for a second type of terminal.

In an embodiment, the first type of terminal includes a RedCap terminal; and/or the second type of terminal includes a legacy terminal (for example, a legacy UE).

In an embodiment, the initial DL BWP may be configured separately for the RedCap terminal and the legacy terminal. For example, the initial DL BWP configured for the RedCap terminal is a separate initial DL BWP, referred to as a first BWP, and the initial DL BWP for the legacy terminal is referred to as the second BWP. Since the initial DL BWPs are different for the two types of terminals, the network-side device may configure the SS for the PEI corresponding to the first type of UE in the first BWP or in the second BWP. This is due to the fact that the first type of terminal (e.g., a first type of UE) may either use the separate initial DL BWP that is specific to the first type of terminal or use the same initial DL BWP as the legacy terminal.

If the RedCap terminal defaults that the SS for the PEI is configured in the first BWP, and the legacy terminal defaults that the SS for the PEI is configured in the second BWP, when the network-side device configures the SS for the PEI for the RedCap terminal in the second BWP, the RedCap terminal cannot determine the SS for the PEI in the first BWP. This not only causes the RedCap terminal to be unable to determine the PEI based on the SS for the PEI, but also wastes resources of the terminal.

If the RedCap terminal and the legacy terminal both default that the SS for the PEI is configured in the second BWP, when the network-side device configures the SS for the PEI for the RedCap terminal in the first BWP, the RedCap terminal cannot determine the SS for the PEI in the second BWP. This not only causes the RedCap terminal to be unable to determine the PEI based on the SS for the PEI, but also wastes resources of the terminal.

It can be seen that when the terminal defaults that the SS for the PEI is configured in a default BWP, there may be a problem that the terminal cannot determine the SS for the PEI, and thus the PEI cannot be determined according to the SS for the PEI.

According to the embodiments of the present application, the terminal can analyze whether the network-side device configure the SS for the PEI in the first BWP or the second BWP based on specific situations, and ensure that the SS for the PEI can be determined in the determined BWP and accurately determine the PEI in the SS.

FIG. 4 is a schematic flowchart illustrating a method for configuring search space according to another embodiment of the present disclosure. As shown in FIG. 4, the configuring the first search space, for the PEI of the first type of terminal, in the first BWP or in the second BWP includes the following step S401.
At step S401, based on a predefined rule, the first search space is configured in the first BWP or in the second BWP.

In an embodiment, based on the predefined rule, the network-side device may configure the first search space for the PEI of the first type of terminal in the first BWP or in the second BWP. It is to be noted that the predefined rule is known to both the network-side device and the terminal (e.g., the first type of terminal and/or the second type of terminal). For example, the predefined rule may be determined based on a protocol agreement, or the predefined rule may be notified to the terminal by the network-side device (e.g., through system information) after the network-side device determines the predefined rule, or the predefined rule may be notified to the network-side device by the terminal after the terminal determines the predefined rule (for example, the terminal reports to the network side device whether the BWP in which the terminal is located is the first BWP or the second BWP).

In the embodiments of the present disclosure, the predefined rule may also be: transmitting the first search space on the initial DL BWP for the first type of terminal. For example, the network-side device may indicate the initial DL BWP for the first type of terminal through a master information block (MIB), and the MIB is also used to instruct the terminal to receive the search space (SS) for transmitting the PEI in the initial DL BWP. In the above embodiment, the MIB indicates that the initial DL BWP for the first type of terminal can be either a first BWP or a second BWP. Of course, this indication may also be transmitted via other messages, which is not limited in the embodiments of the present disclosure.

Based on a predefined rule or a communication protocol, the first type of terminal can also determine whether the network-side device configures the first search space in the first BWP or in the second BWP. For example, when it is determined that the network-side device configures the first search space in the first BWP, the first type of terminal can determine the first search space in the first BWP, so as to ensure that the first search space can be successfully determined, and thereby the PEI can be determined in the first search space. For example, when it is determined that the network-side device configures the first search space in the second BWP, the first type of terminal can determine the first search space in the second BWP, so as to ensure that the first search space can be successfully determined, and thereby the PEI can be determined in the first search space.

FIG. 5 is a schematic flowchart illustrating a method for configuring search space according to yet another embodiment of the present disclosure. As shown in FIG. 5, the configuring, based on the predefined rule, the first search space in the first BWP or in the second BWP includes the following steps S501 to S502.
At step S501, a target BWP is determined, where a search space for paging signaling monitored by the first type of terminal is in the target BWP.
At step S502, the first search space is configured in the target BWP.

In an embodiment, the predefined rule may be that the first search space and the search space for the paging monitored by the first type of terminal are configured in the same BWP, then the BWP where the search space for the paging monitored by the first type of terminal is located may be determined first, for example, called the target BWP, and the target BWP may include the first BWP. Furthermore, the first search space can be configured in the target BWP.

Accordingly, the first type of terminal can first determine the target BWP where the search space for the monitored paging is located, and then determine the first search space in the target BWP.

Accordingly, after determining the first search space in the target BWP, the terminal can determine the PEI in the first search space, and determine whether it is necessary to monitor paging signaling in the corresponding DRX cycle according to the determined PEI, and the search space for the paging signaling can also be determined in the target BWP. In this process, the terminal determines the first search space and determines the search space for the paging signaling both on the same BWP, thereby there is no need to switch BWP, which is beneficial to simplify the operation.

In an embodiment, the method for configuring search space further includes configuring a second search space, for a PEI of the second type of terminal, in the second BWP.

On the basis of the network-side device configuring the first search space for the first type of terminal in the target BWP, such as a first BWP, the network-side device may also configure a second search space for a PEI of a second type of terminal in the second BWP. That is, the network-side device configures at least one search space for a PEI and transmits a configuration of at least one SS for a PEI.

In an embodiment, the configuration information for the first search space (called a first configuration) and the configuration information for the second search space (called a second configuration) may be the same or different. For example, they can be partially the same (for example, there is partial overlap of frequency domain resources) or completely different (for example, there is no overlap of frequency domain resources), and can be configured as required.

In all embodiments of the present disclosure, the first search space corresponding to the first type of terminal may be configured in the first BWP or the second BWP. In some possible implementations, the configuration parameter for the first search space when configured in the first BWP may be the same as or different from the configuration parameter for the first search space when configured in the second BWP. That the configuration parameters for the first search space may be the same means that the relative resource positions (e.g., relative frequency domain positions and/or relative time domain positions) of the first search space in the first BWP and in the second BWP may be the same (e.g., in the case where the first BWP partially overlaps with the second BWP, the first BWP is within the second BWP, the second BWP is within the first BWP, and so forth), or the configuration parameters for the first search space may be different.

FIG. 6 is a schematic flowchart illustrating a method for configuring search space according to yet another embodiment of the present disclosure. As shown in FIG. 6, the configuring, based on the predefined rule, the first search space in the first BWP or in the second BWP includes the following step S601.
At step S601, the first search space is configured in the second BWP.

In an embodiment, the predefined rule may be to configure the first search space in the second BWP, then the network-side device may configure the first search space in the second BWP. Accordingly, the first type of terminal can determine the first search space in the second BWP.

Accordingly, since the second search space for the PEI of the second type of terminal is also configured in the second BWP, the network-side device can configure the search spaces for the PEIs of both types of terminals in the second BWP without the need to configure them separately in different BWPs, which is conducive to simplifying the configuration process of the network-side device. In the embodiments of the present disclosure, the first search space corresponding to the first type of terminal and the second search space corresponding to the second type of terminal may be the same or different, which is not limited thereto.

In an embodiment, the method for configuring search space further includes indicating, by a broadcast message, configuration information for the second BWP to the first type of terminal.

Since the first BWP is an initial DL BWP configured for the first type of terminal, and the second BWP is an initial DL BWP configured for the second type of terminal, the second BWP is unknown to the first type of terminal. Therefore, when configuring the first search space in the second BWP, the network-side device needs to indicate the configuration information for the second BWP to the first type of terminal through the broadcast message, so that the first type of terminal can determine the second BWP, and then the first search space can be determined in the second BWP. For example, the configuration information for the second BWP includes a number of the second BWP. The terminal (e.g., UE) may determine which BWP is the second BWP based on a pre-configured correspondence between a number of each BWP and the configuration parameters. For another example, the configuration information for the second BWP includes at least one of: a time domain position of the second BWP and frequency domain position information of the second BWP. The terminal can determine the second BWP according to the configuration information for the second BWP. Of course, these are all examples. In the embodiments of the present disclosure, the second BWP can be indicated for the first type of terminal in any possible way, which is not repeated herein.

In an embodiment, the broadcast message includes at least one of system information, or paging signaling.

The network-side device may indicate the configuration information for the second BWP to the first type of terminal through the system information, or may indicate the configuration information for the second BWP to the first type of terminal through the paging signaling. When the configuration information for the second BWP is indicated to the first type of terminal through the system information, the system information may be a master information block (MIB) or a system information block (SIB), such as SIB1. The specifics can be determined by the network-side device as needed.

That is, the network-side device may indicate the initial DL BWP for the first type of terminal through a master information block (MIB), and the MIB is also used to instruct the terminal to receive the search space (SS) for transmitting the PEI in the initial DL BWP. In the above embodiment, the MIB indicates that the initial DL BWP for the first type of terminal can be either a first BWP or a second BWP. Of course, this indication may also be transmitted via other messages, which is not limited in the embodiments of the present disclosure.

In an embodiment, the first search space is the same as the second search space for the PEI of the second type of terminal.

When the network-side device configures the first search space in the second BWP, because the second search space for the PEI of the second type terminal is also configured in the second BWP, the first search space and the second search space can adopt the same configuration information, which is beneficial to simplifying the configuration operation of the network-side device.

It is to be noted that when both the first search space and the second search space are configured in the second BWP, the network-side device may also choose to use different configuration information for the first search space and the second search space.

In an embodiment, a resource corresponding to the PEI monitored by the first type of terminal in the first search space is the same as a resource corresponding to a PEI monitored by the second type of terminal in a second search space. That is, a corresponding PEI, for the first type of terminal and the second type of terminal, in the second BWP is the same PEI.

In the case where the first search space and the second search space are the same, the network-side device may further configure that the resource corresponding to the PEI monitored by the first type of terminal in the first search space is the same as the resource corresponding to the PEI monitored by the second type of terminal in the second search space, whereby it is advantageous to further simplify the configuration operation of the network-side device.

It is to be noted that in the case where the first search space and the second search space can adopt the same configuration information, the network-side device may also configure that the resource corresponding to the PEI monitored by the first type of terminal in the first search space is different from the resource corresponding to the PEI monitored by the second type of terminal in the second search space.

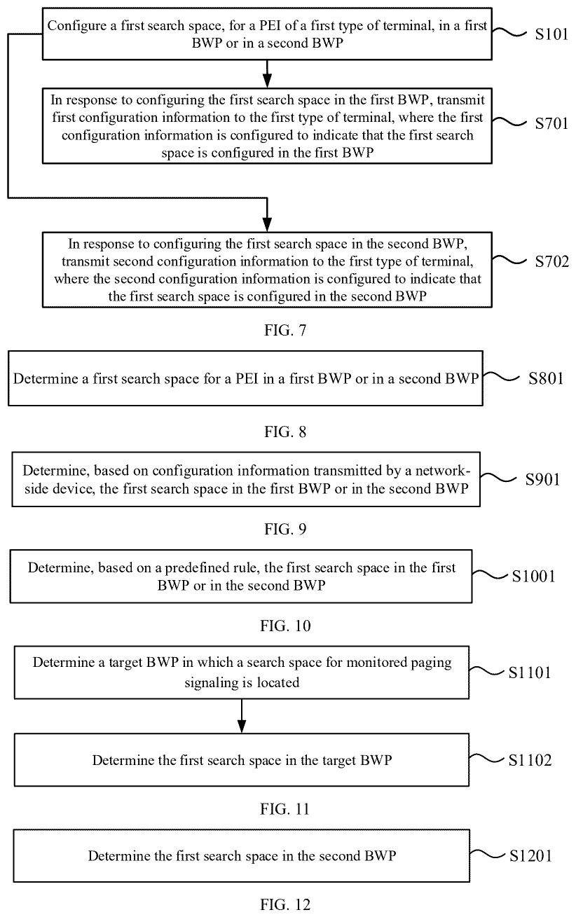

FIG. 7 is a schematic flowchart illustrating a method for configuring search space according to yet another embodiment of the present disclosure. As shown in FIG. 7, the method for configuring search space includes previously described step S101 and further includes the following step S701.
At step S701, in response to configuring the first search space in the first BWP, first configuration information is transmitted to the first type of terminal, where the first configuration information is configured to indicate that the first search space is configured in the first BWP.

Alternatively, the method for configuring search space further includes the following step S702.
At step S702, in response to configuring the first search space in the second BWP, second configuration information is transmitted to the first type of terminal, where the second configuration information is configured to indicate that the first search space is configured in the second BWP.

In an embodiment, instead of configuring the first search space in the first BWP or in the second BWP according to the predefined rule, the network-side device may also choose to configure the first search space in the first BWP or in the second BWP according to the actual need, and transmit configuration information to the first type of terminal to indicate which BWP the first search space is configured in.

For example, the network-side device configures the first search space in the first BWP, and the network-side device may transmit the first configuration information to the first type of terminal, where the first configuration information is configured to indicate that the first search space is configured in the first BWP. Accordingly, the first type of terminal can determine the first search space in the second BWP according the first configuration information. For example, the network-side device configures the first search space in the second BWP, and the network-side device may transmit the second configuration information to the first type of terminal, where the second configuration information is configured to indicate that the first search space is configured in the second BWP. Accordingly, the first type of terminal can determine the first search space in the second BWP according the second configuration information. In the embodiments, the first configuration information and the second configuration information can be a field of control signaling, of which a value is used to indicate whether the first search space is configured in the first BWP or in the second BWP, that is, explicit indication. The first configuration information and the second configuration information may also be different control signaling or different fields of the same control signaling. In the embodiments, the first configuration information and the second configuration information may be implicit indication. For example, different encoding methods are used to indicate that the first search space is configured in the first BWP or in the second BWP, or different preset information is used to indicate that the first search space is configured in the first BWP or in the second BWP (for example, when the UE receives preset information, the UE can know that the first search space is configured in the first BWP or in the second BWP).

FIG. 8 is a schematic flowchart illustrating a method for determining search space according to an embodiment of the present disclosure. The method for determining search space shown in this embodiment may be performed by a first type of terminal. The first type of terminal includes, but is not limited to, a communication device such as a cell phone, a tablet, a wearable device, a sensor, an internet of things (IoT) device, and the like. For example, the first type of terminal includes a reduced capability (RedCap) terminal. The first type of terminal may communicate with a network-side device, the network-side device includes, but is not limited to a network-side device (such as a base station, a core network, and the like) in a communication system such as a 4th generation (4G) communication system, 5G communication system, 6G communication system, etc.

As shown in FIG. 8, the method for determining search space may include the following step S801. At step S801, a first search space for a paging early indication (PEI) is determined in a first bandwidth part (BWP) or in a second BWP.

In an embodiment, in a discontinuous reception (DRX) scenario, the terminal can monitor paging signaling transmitted by the network-side device in the paging occasion (PO) in each DRX cycle. However, the network-side device does not necessarily transmit paging signaling in each DRX cycle. When the network-side device does not transmit paging signaling in a DRX cycle, the terminal performs the monitoring in the PO of this DRX cycle, which will result in waste of resources of the terminal.

As shown in FIG. 2, illustrated by an example of three DRX cycles, as shown in FIG. 3, based on the embodiment shown in FIG. 2, the network-side device can transmit a PEI in each of the three DRX cycles.

According to the present disclosure, the network-side device can configure the first search space, for the PEI of the first type of terminal, in the first BWP or in the second BWP, such that the first type of terminal can explicitly determine the search space for the PEI in the first BWP or in the second BWP, so as to determine the BWP accurately, and thus can obtain the PEI in the determined search space for the PEI.

In an embodiment, the first type of terminal monitors a paging message on the first BWP.

In an embodiment, the first BWP includes an initial DL BWP for the first type of terminal; and/or the second BWP includes an initial DL BWP for a second type of terminal.

In an embodiment, the first type of terminal includes a RedCap terminal; and/or the second type of terminal includes a legacy terminal (for example, a legacy UE).

In an embodiment, the initial DL BWP may be configured separately for the RedCap terminal and the legacy terminal. For example, the initial DL BWP configured for the RedCap terminal is a separate initial DL BWP, referred to as a first BWP, and the initial DL BWP for the legacy terminal is referred to as the second BWP. Since the initial DL BWPs are different for the two types of terminals, the network-side device may configure the SS for the PEI in the first BWP or in the second BWP.

If the RedCap terminal defaults that the SS for the PEI is configured in the first BWP, and the legacy terminal defaults that the SS for the PEI is configured in the second BWP, when the network-side device configures the SS for the PEI for the RedCap terminal in the second BWP, the RedCap terminal cannot determine the SS for the PEI in the first BWP. This not only causes the RedCap terminal to be unable to determine the PEI based on the SS for the PEI, but also wastes resources of the terminal.

If the RedCap terminal and the legacy terminal both default that the SS for the PEI is configured in the second BWP, when the network-side device configures the SS for the PEI for the RedCap terminal in the first BWP, the RedCap terminal cannot determine the SS for the PEI in the second BWP. This not only causes the RedCap terminal to be unable to determine the PEI based on the SS for the PEI, but also wastes resources of the terminal.

It can be seen that when the terminal defaults that the SS for the PEI is configured in a default BWP, there may be a problem that the terminal cannot determine the SS for the PEI, and thus the PEI cannot be determined according to the SS for the PEI.

According to the embodiments of the present application, the terminal can analyze whether the network-side device configure the SS for the PEI in the first BWP or the second BWP based on specific situations, and ensure that the SS for the PEI can be determined in the determined BWP and accurately determine the PEI in the SS.

FIG. 9 is a schematic flowchart illustrating a method for determining search space according to another embodiment of the present disclosure. As shown in FIG. 9, the determining the first search space for the PEI in the first BWP or in the second BWP includes the following step S901.
At step S901, based on configuration information transmitted by a network-side device, the first search space is determining in the first BWP or in the second BWP.

In an embodiment, the determining, based on the configuration information transmitted by the network-side device, the first search space in the first BWP or in the second BWP includes: in response to receiving first configuration information transmitted by the network-side device, determining the first search space in the first BWP; or in response to receiving second configuration information transmitted by the network-side device, determining the first search space in the second BWP.

In an embodiment, the network-side device may configure the first search space in the first BWP or in the second BWP according to the actual need, and transmit configuration information to the first type of terminal to indicate which BWP the first search space is configured in.

For example, when the network-side device configures the first search space in the first BWP, the network-side device may transmit the first configuration information to the first type of terminal, where the first configuration information is configured to indicate that the first search space is configured in the first BWP. Accordingly, the first type of terminal can determine the first search space in the second BWP according the configuration information.

For example, when the network-side device configures the first search space in the second BWP, the network-side device may transmit the second configuration information to the first type of terminal, where the second configuration information is configured to indicate that the first search space is configured in the second BWP. Accordingly, the first type of terminal can determine the first search space in the second BWP according the second configuration information.

FIG. 10 is a schematic flowchart illustrating a method for determining search space according to yet another embodiment of the present disclosure. As shown in FIG. 10, the determining the first search space for the PEI in the first BWP or in the second BWP includes the following step S1001.
At step S1001, based on a predefined rule, the first search space is determined in the first BWP or in the second BWP.

In an embodiment, based on the predefined rule or the communication protocol, the network-side device may configure the first search space for the PEI of the first type of terminal in the first BWP or in the second BWP. It is to be noted that the predefined rule is known to both the network-side device and the terminal (e.g., the first type of terminal and/or the second type of terminal). For example, the predefined rule may be determined based on a protocol agreement, or the predefined rule may be notified to the terminal by the network-side device (e.g., through system information) after the network-side device determines the predefined rule, or the predefined rule may be notified to the network-side device by the terminal after the terminal determines the predefined rule (for example, the terminal reports to the network side device whether the BWP in which the terminal is located is the first BWP or the second BWP, so as to instruct the terminal to send the search space for transmitting the PEI on the corresponding BWP).

In the embodiments of the present disclosure, the predefined rule may also be: transmitting the first search space on the initial DL BWP of the first type of terminal. For example, the network-side device may indicate the initial DL BWP for the first type of terminal through a master information block (MIB), and the MIB is also used to instruct the terminal to receive the search space (SS) for transmitting the PEI in the initial DL BWP. In the above embodiment, the MIB indicates that the initial DL BWP for the first type of terminal can be either a first BWP or a second BWP. Of course, this indication may also be transmitted via other messages, which is not limited in the embodiments of the present disclosure.

Based on the predefined rule or the communication protocol, the first type of terminal can also determine whether the network-side device configures the first search space in the first BWP or in the second BWP. For example, when it is determined that the network-side device configures the first search space in the first BWP, the first type of terminal can determine the first search space in the first BWP, so as to ensure that the first search space can be successfully determined, and thereby the PEI can be determined in the first search space. For example, when it is determined that the network-side device configures the first search space in the second BWP, the first type of terminal can determine the first search space in the second BWP, so as to ensure that the first search space can be successfully determined, and thereby the PEI can be determined in the first search space.

FIG. 11 is a schematic flowchart illustrating a method for determining search space according to yet another embodiment of the present disclosure. As shown in FIG. 11, the determining, based on the predefined rule, the first search space in the first BWP or in the second BWP includes the following steps S1101 to S1102.
At step S1101, a target BWP is determined, where a search space for monitored paging signaling is in the target BWP.
At step S1102, the first search space is determined in the target BWP.

In an embodiment, the predefined rule may be that the first search space and the search space for the paging monitored by the first type of terminal are configured in the same BWP, then the BWP where the search space for the paging monitored by the first type of terminal is located may be determined first, for example, called the target BWP, and the target BWP may include the first BWP. Furthermore, the first search space can be configured in the target BWP.

Accordingly, the first type of terminal can first determine the target BWP where the search space for the monitored paging is located, and then determine the first search space in the target BWP.

Accordingly, after determining the first search space in the target BWP, the terminal can determine the PEI in the first search space, and determine whether it is necessary to monitor paging signaling in the corresponding DRX cycle according to the determined PEI, and the search space for the paging signaling can also be determined in the target BWP. In this process, the terminal determines the first search space and determines the search space for the paging signaling both on the same BWP, thereby there is no need to switch BWP, which is beneficial to simplify the operation.

FIG. 12 is a schematic flowchart illustrating a method for determining search space according to yet another embodiment of the present disclosure. As shown in FIG. 12, the determining, based on the predefined rule, the first search space in the first BWP or in the second BWP includes the following step S1201.
At step S1201, the first search space is determined in the second BWP.

In an embodiment, the predefined rule may be to configure the first search space in the second BWP, then the network-side device may configure the first search space in the second BWP. Accordingly, the first type of terminal can determine the first search space in the second BWP.

Accordingly, since the second search space for the PEI of the second type of terminal is also configured in the second BWP, the network-side device can configure the search spaces for the PEIs of both types of terminals in the second BWP without the need to configure them separately in different BWPs, which is conducive to simplifying the configuration process of the network-side device.

In an embodiment, the method for determining search space further includes: determining, based on a broadcast message transmitted by the network-side device, the second BWP.

Since the first BWP is an initial DL BWP configured for the first type of terminal, and the second BWP is an initial DL BWP configured for the second type of terminal, configuration parameters of the second BWP are unknown to the first type of terminal. Therefore, when configuring the first search space in the second BWP, the network-side device needs to indicate the second BWP to the first type of terminal through the broadcast message, so that the first type of terminal can determine the second BWP, and then the first search space can be determined in the second BWP.

In an embodiment, the broadcast message includes at least one of: system information, or paging signaling.

The network-side device may indicate the second BWP to the first type of terminal through the system information, or may indicate the second BWP to the first type of terminal through the paging signaling. When the second BWP is indicated to the first type of terminal through the system information, the system information may be a master information block (MIB) or a system information block (SIB), such as SIB1. The specifics can be determined by the network-side device as needed.

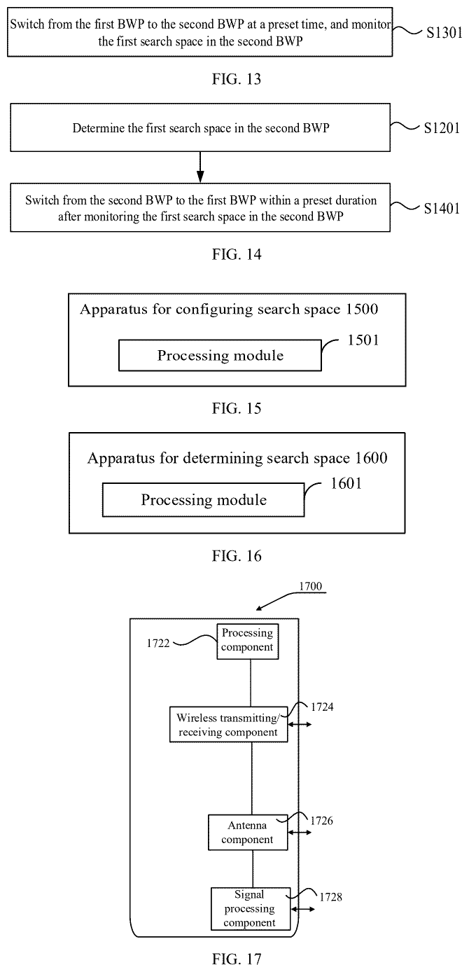

FIG. 13 is a schematic flowchart illustrating a method for determining search space according to yet another embodiment of the present disclosure. As shown in FIG. 13, the determining the first search space in the second BWP includes the following step S1301.
At step S1301, the first type of terminal switches from the first BWP to the second BWP at a preset time, and monitors the first search space in the second BWP.

In an embodiment, for the first type of terminal, the first BWP is the initial DL BWP configured by the network-side device, so the first type of terminal generally communicates with the network-side device on the initial DL BWP by default. When the SS for the PEI needs to be monitored on the second BWP, the first type of terminal needs to switch from the first BWP to the second BWP, and then monitors the first search space in the second BWP.

The preset time for switching from the first BWP to the second BWP may be configured by the network-side device or determined based on the protocol agreement.

FIG. 14 is a schematic flowchart illustrating a method for determining search space according to yet another embodiment of the present disclosure. As shown in FIG. 14, the method for determining search space as previously described in step S1201, further includes the following step S1401.
At step S1401, the first type of terminal switches from the second BWP to the first BWP within a preset duration after monitoring the first search space in the second BWP.

In an embodiment, for the first type of terminal, the first BWP is the initial DL BWP configured by the network-side device, so the first type of terminal generally communicates with the network-side device on the initial DL BWP by default. When the first type of terminal finishes monitoring the first search space in the second BWP, the first type of terminal can switch from the second BWP to the first BWP to continue communication with the network-side device.

The first type of terminal switches from the second BWP to the first BWP within the preset duration after the first type of terminal monitors the first search space in the second BWP. The preset duration may be configured by the network-side device or determined based on the protocol agreement.

For example, if the preset duration may be 0, the first type of terminal will switch from the second BWP to the first BWP immediately after monitoring the first search space in the second BWP. For example, the preset duration may be greater than 0 (for example, when the first BWP is busy), the first type of terminal can continue to communicate with the network-side device on the second BWP for a period of time after monitoring the first search space in the second BWP, and then switch from the second BWP to the first BWP.

In an embodiment, a duration between a first time domain resource corresponding to the PEI in the first search space and a second time domain resource corresponding to the paging message to be monitored is greater than a preset number of time domain units.

The duration between the first time domain resource corresponding to the PEI in the first search space and the second time domain resource corresponding to the paging message to be monitored needs to be greater than the preset number of time domain units, regardless of whether the first type of terminal is in the first BWP or the second BWP, such that it is to ensure that the first type of terminal can complete the analysis of the PEI within the preset number of time domain units, and thus determine, based on the PEI, whether or not there is a need to monitor paging signaling in the PO corresponding to the DRX.

The preset number of time domain units (e.g., a time domain symbol (e.g., an orthogonal frequency-division-multiplexing symbol), a time slot) may be configured by the network-side device or agreed upon by the protocol.

It is to be noted that the specific implementation of the network-side device in the embodiments of the present disclosure may correspond to the specific implementation of the terminal, so the corresponding contents are not repeated herein.

The present disclosure also provides an apparatus for configuring search space and an apparatus for determining search space corresponding to the foregoing embodiments of the method for configuring search space and the method for determining search space, respectively.

FIG. 15 is a block diagram illustrating an apparatus for configuring search space 1500 according to an embodiment of the present disclosure. The apparatus for configuring search space 1500 shown in this embodiment can be applied to a network-side device, which can communicate with a terminal. The network-side device includes, but is not limited to, a base station (such as a 4G base station, a 5G base station, a 6G base station and the like) in a communication system. The terminal includes, but is not limited to, a communication device such as a mobile phone, a tablet, a wearable device, a sensor, and an internet of thing (IoT) device.

As shown in FIG. 15, the apparatus for configuring search space 1500 may include a processing module 1501.

The processing module 1501 is configured to configure a first search space, for a paging early indication (PEI) of a first type of terminal, in a first bandwidth part (BWP) or in a second BWP.

In an embodiment, the first type of terminal monitors a paging message on the first BWP.

In an embodiment, the first BWP includes an initial DL BWP for the first type of terminal; and/or the second BWP includes an initial DL BWP for a second type of terminal.

In an embodiment, the first type of terminal includes a reduced capability (RedCap) terminal; and/or the second type of terminal includes a legacy terminal (for example, a legacy UE).

In an embodiment, the processing module 1501 is configured to configure, based on a predefined rule, the first search space in the first BWP or in the second BWP.

In an embodiment, the processing module 1501 is configured to determine a target BWP, where a search space for paging signaling monitored by the first type of terminal is in the target BWP.

In an embodiment, the processing module 1501 is further configured to configure a second search space, for a PEI of the second type of terminal, in the second BWP.

In an embodiment, a first configuration of the first search space and a second configuration of the second search space are totally different, or partially the same, or all the same.

In an embodiment, the processing module 1501 is configured to configure the first search space in the second BWP.

In an embodiment, the apparatus for configuring search space further includes a transmitting module, configured to indicate, by a broadcast message, the second BWP to the first type of terminal.

In an embodiment, the broadcast message includes at least one of: system information, or paging signaling.

In an embodiment, the first search space is the same as the second search space for the PEI of the second type of terminal.

In an embodiment, a resource corresponding to the PEI monitored by the first type of terminal in the first search space is the same as a resource corresponding to a PEI monitored by the second type of terminal in a second search space.

In an embodiment, the processing module 1501 is configured to, in response to configuring the first search space in the first BWP, transmit first configuration information to the first type of terminal, where the first configuration information is configured to indicate that the first search space is configured in the first BWP.

Alternatively, the processing module 1501 is configured to, in response to configuring the first search space in the second BWP, transmit second configuration information to the first type of terminal, where the second configuration information is configured to indicate that the first search space is configured in the second BWP.

FIG. 16 is a block diagram illustrating an apparatus for determining search space 1600 according to an embodiment of the present disclosure. The apparatus for determining search space 1600 shown in this embodiment may be applied to a first type of terminal. The first type of terminal includes, but is not limited to, a communication device such as a cell phone, a tablet, a wearable device, a sensor, an internet of things (IoT) device, and the like. For example, the first type of terminal includes a reduced capability (RedCap) terminal. The first type of terminal may communicate with a network-side device, the network-side device includes, but is not limited to a network-side device (such as a base station, a core network, and the like) in a communication system such as a 4th generation (4G) communication system, 5G communication system, 6G communication system, etc.

As shown in FIG. 16, the apparatus for determining search space 1600 may include a processing module 1601.

The processing module 1601 is configured to determine a first search space for a paging early indication (PEI) in a first bandwidth part (BWP) or in a second BWP.

In an embodiment, the first type of terminal monitors a paging message on the first BWP.

In an embodiment, the first BWP includes an initial DL BWP for the first type of terminal; and/or the second BWP includes an initial DL BWP for a second type of terminal.

In an embodiment, the first type of terminal includes a reduced capability (RedCap) terminal; and/or the second type of terminal includes a legacy terminal (for example, a legacy UE).

In an embodiment, the processing module 1601 is configured to determine, based on configuration information transmitted by the network-side device, the first search space in the first BWP or in the second BWP.

In an embodiment, the processing module 1601 is configured to: in response to receiving first configuration information transmitted by the network-side device, determine the first search space in the first BWP; or in response to receiving second configuration information transmitted by the network-side device, determine the first search space in the second BWP.

In an embodiment, the processing module 1601 is configured to determine, based on a predefined rule, the first search space in the first BWP or in the second BWP.

In an embodiment, the processing module 1601 is configured to: determine a target BWP in which a search space for monitored paging signaling is located; and determine the first search space in the target BWP.

In an embodiment, the processing module 1601 is configured to determine the first search space in the second BWP.

In an embodiment, the apparatus for determining search space further includes a receiving module, configured to determine, based on a broadcast message transmitted by the network-side device, the second BWP.

In an embodiment, the broadcast message includes at least one of: system information, or paging signaling.

In an embodiment, the processing module 1601 is configured to switch from the first BWP to the second BWP at a preset time, and monitors the first search space in the second BWP.

In an embodiment, the processing module 1601 is configured to switch from the second BWP to the first BWP within a preset duration after monitoring the first search space in the second BWP.

In an embodiment, a duration between a first time domain resource corresponding to the PEI in the first search space and a second time domain resource corresponding to the paging message to be monitored is greater than a preset number of time domain units.

With regard to the device in the above examples, the specific manner in which the respective modules perform the operations has been described in detail in the examples of the related methods, and will not be explained in detail herein.

Since the embodiments of the apparatus substantially corresponds to the embodiments of the method, relevant parts may be referred to the description of the embodiments of the method. The apparatus examples described above are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the examples. It may be understood and implemented by those skilled in the art without creative work.

According to an embodiment of the present disclosure, there is provided a communication device, including: a processor (also referred to as a processing module); and a memory storing computer programs, where the computer programs, when executed by the processor, cause the processor to perform the method for configuring search space in any one of the embodiments.

According to an embodiment of the present disclosure, there is provided a communication device, including: a processor; and a memory storing computer programs, where the computer programs, when executed by the processor, cause the processor to perform the method for determining search space in any one of the embodiments.

According to an embodiment of the present disclosure, there is provided a computer-readable storage medium, storing computer programs thereon, where the computer programs, when executed by a processor, cause the processor to perform the method for configuring search space in any one of the embodiments.

According to an embodiment of the present disclosure, there is provided a computer-readable storage medium, storing computer programs thereon, where the computer programs, when executed by a processor, cause the processor to perform the method for determining search space in any one of the embodiments.

FIG. 17 is a block diagram illustrating a device 1700 for configuring search space according to an embodiment of the present disclosure. The device 1700 may be provided as a base station. Referring to FIG. 17, the device 1700 includes a processing component 1722, a wireless transmitting/receiving component 1724, an antenna component 1726, and a signal processing component 1728 specific to a wireless interface. The processing component 1722 may further include one or more processors (not shown). One of the processors in the processing component 1722 may be configured to perform the method for configuring search space in any one of the embodiments.

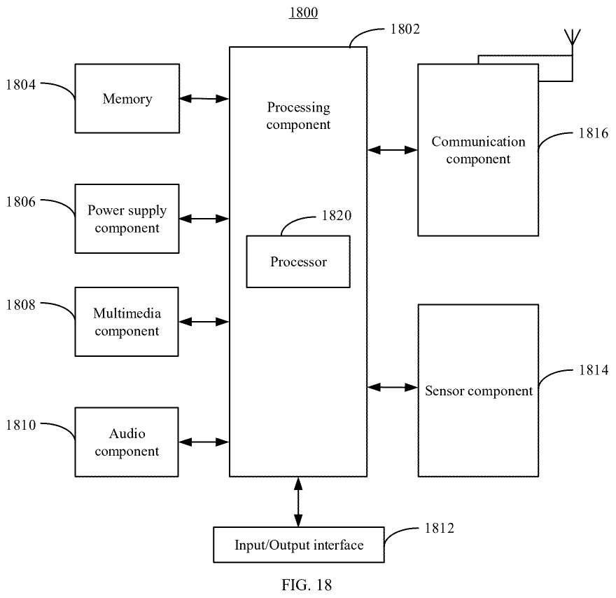

FIG. 18 is a block diagram illustrating a device 1800 for determining search space according to an embodiment of the present disclosure. For example, the device 1800 can be a mobile phone, a computer, a digital broadcast terminal, a message transmitting and receiving device, a gaming console, a tablet device, a medical device, a fitness device, a personal digital assistant, and the like.

Referring to FIG. 18, the device 1800 can include one or more of the following components: a processing component 1802, a memory 1804, a power supply component 1806, a multimedia component 1808, an audio component 1810, an input/output (I/O) interface 1812, a sensor component 1814, and a communication component 1816.

The processing component 1802 usually controls overall operations of the device 1800, such as operations related to display, a telephone call, data communication, a camera operation and a record operation. The processing component 1802 may include one or more processors 1820 to execute instructions to complete all or a part of the steps of the method for determining search space. Further, the processing component 1802 may include one or more modules to facilitate interaction between the processing component 1802 and another component. For example, the processing component 1802 may include a multimedia module to facilitate the interaction between the multimedia component 1808 and the processing component 1802.

The memory 1804 is configured to store different types of data to support the operations of the device 1800. Examples of such data include instructions, contact data, phone book data, messages, pictures, videos, and so on for any application or method that operates on the device 1800. The memory 1804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or optical disk.

The power supply component 1806 provides power for different components of the device 1800. The power supply component 1806 may include a power management system, one or more power sources, and other components associated with generating, managing and distributing power for the device 1800.

The multimedia component 1808 includes a screen for providing an output interface between the device 1800 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 1808 may include a front camera and/or a rear camera. When the device 1800 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 1810 is configured to output and/or input an audio signal. For example, the audio component 1810 may include a microphone (MIC). When the device 1800 is in an operating mode, such as a call mode, a recording mode and a speech recognition mode, the microphone is configured to receive an external audio signal. The received audio signal may be further stored in the memory 1804 or sent via the communication component 1816. In some embodiments, the audio component 1810 also includes a speaker for outputting an audio signal.

The I/O interface 1812 provides an interface between the processing component 1802 and a peripheral interface module which may be a keyboard, a click wheel, a button, or the like. Such buttons may include but not limited to: a home button, a volume button, a start button and a lock button.

The sensor component 1814 includes one or more sensors for providing state assessments in different aspects for the device 1800. For example, sensor component 1814 can detect an open/closed state of device 1800, a relative positioning of components, such as the display and keypad of device 1800, and sensor component 1814 can also detect a change in position of device 1800 or a component of device 1800, the presence or absence of user contact with device 1800, orientation or acceleration/deceleration of device 1800, and temperature change of device 1800. The sensor component 1814 may include a proximity sensor configured to detect presence of a nearby object without any physical contact. The sensor component 1814 may also include an optical sensor, such as a CMOS or CCD image sensor used in an imaging application. In some examples, the sensor component 1814 may also include an acceleration sensor, a gyro sensor, a magnetic sensor, a pressure sensor, or a temperature sensor.

The communication component 1816 is configured to facilitate wired or wireless communication between the device 1800 and other devices. The device 1800 may access a wireless network based on a communication standard, such as WiFi, 2G, 3G, 4G LTE, 5G NR, or a combination thereof. In some embodiments, the communication component 1816 may receive a broadcast signal or broadcast-related information from an external broadcast management system via a broadcast channel. In an example, the communication component 1816 may also include a near field communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology, and other technologies.

In an example, the device 1800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the method for determining search space in any one of the embodiments.

In an example, a non-transitory computer readable storage medium including instructions, such as the memory 1804 including instructions, is also provided. The above instructions may be executed by the processor 1820 of the device 1800 to complete the method for determining search space. For example, the non-transitory computer readable storage medium may be a read-only memory (ROM), a random access memory (RAM), a CD-ROM, a magnetic tape, a floppy disk and an optical data storage device, etc.

According to the present disclosure, the network-side device can configure the first search space, for the PEI of the first type of terminal, in the first BWP or in the second BWP, such that the first type of terminal can explicitly determine the search space for the PEI in the first BWP or in the second BWP, so as to determine the BWP accurately, and thus can obtain the PEI in the determined search space.

In the case where the first type of terminal includes a reduced capability (RedCap) terminal, the RedCap terminal does not default that the SS for the PEI is configured in a default BWP, but can analyze whether the network-side device configure the SS for the PEI in the first BWP or the second BWP based on specific situations, and ensure that the SS for the PEI can be determined in the determined BWP and accurately determine the PEI in the SS.

After considering the specification and practicing the present disclosure, the persons of skill in the prior art may easily conceive of other implementations of the present disclosure. The present disclosure is intended to cover any variations, uses, modification or adaptations of the present disclosure that follow the general principles thereof and include common knowledge or conventional technical means in the art that are not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the disclosure is to be limited only by the appended claims.

It shall be noted that the relational terms such as “first” and “second” used herein are merely intended to distinguish one entity or operation from another entity or operation rather than to require or imply any such actual relation or order existing between these entities or operations. Also, the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

The methods and apparatuses of the present disclosure are described herein in detail. The principle and implementation of the present disclosure are described herein through specific examples. The description about the embodiments of the present disclosure is merely provided for ease of understanding of the method and core ideas of the present disclosure. Persons of ordinary skill in the art can make variations and modifications to the present disclosure in terms of the specific implementations and application scopes according to the ideas of the present disclosure. Therefore, the specification shall not be construed as a limit to the present disclosure.

1. A method for configuring search space, performed by a network-side device, and comprising:
configuring a first search space, for a paging early indication (PEI) of a first type of terminal, in one of a first bandwidth part (BWP) or a second BWP.

2. The method of claim 1, wherein the first type of terminal monitors a paging message on the first BWP.

3. The method of claim 1, wherein
on a condition that the first search space is in the first BWP, the first BWP comprises an initial downlink (DL) BWP for the first type of terminal, and the first type of terminal comprises a reduced capability (RedCap) terminal; and
on a condition that the first search space is in the second BWP, the second BWP comprises an initial DL BWP for a second type of terminal, and the second type of terminal comprises a legacy terminal.

4. (canceled)

5. The method of claim 3, wherein the configuring the first search space, for the PEI of the first type of terminal, in one of the first BWP or the second BWP comprises:
configuring, based on a predefined rule, the first search space in one of the first BWP or the second BWP.

6. The method of claim 5, wherein the configuring, based on the predefined rule, the first search space in one of the first BWP or the second BWP comprises one of:
configuring the first search space in the second BWP; or
determining a target BWP in which a search space for paging signaling monitored by the first type of terminal is located, and
configuring the first search space in the target BWP.

7. The method of claim 5, further comprising:
configuring a second search space, for a PEI of the second type of terminal, in the second BWP, and
wherein a first configuration of the first search space and a second configuration of the second search space are either completely different, partially the same, or all the same.

8-9. (canceled)

10. The method of claim 6, further comprising:
indicating, by a broadcast message, the second BWP to the first type of terminal, and
wherein the broadcast message comprises at least one of system information or paging signaling.

11. (canceled)

12. The method of claim 6, wherein
the first search space is the same as a second search space for a PEI of the second type of terminal, and
a resource corresponding to the PEI monitored by the first type of terminal in the first search space is the same as a resource corresponding to the PEI monitored by the second type of terminal in the second search space.

13. (canceled)

14. The method of claim 1, further comprising:
in response to configuring the first search space in the first BWP, transmitting first configuration information to the first type of terminal, wherein the first configuration information is configured to indicate that the first search space is configured in the first BWP; or
in response to configuring the first search space in the second BWP, transmitting second configuration information to the first type of terminal, wherein the second configuration information is configured to indicate that the first search space is configured in the second BWP.

15. A method for determining search space, performed by a first type of terminal, and comprising:
determining a first search space for a paging early indication (PEI) in one of a first bandwidth part (BWP) or a second BWP.

16. The method of claim 15, wherein
the first type of terminal monitors a paging message on the first BWP,
on a condition that the first search space is in the first BWP, the first BWP comprises an initial downlink (DL) BWP for the first type of terminal, and the first type of terminal comprises a reduced capability (RedCap) terminal, and
on a condition that the first search space is in the second BWP, the second BWP comprises an initial DL BWP for a second type of terminal, and the second type of terminal comprises a legacy terminal.

17. -18. (canceled)

19. The method of claim 15, wherein the determining the first search space for the PEI in one of the first BWP or the second BWP comprises either:
determining, based on configuration information transmitted by a network-side device, the first search space in one of the first BWP or the second BWP, or
determining, based on a predefined rule, the first search space in one of the first BWP or the second BWP.

20. The method of claim 19, wherein the determining, based on the configuration information transmitted by the network-side device, the first search space in one of the first BWP or the second BWP comprises:
in response to receiving first configuration information transmitted by the network-side device, determining the first search space in the first BWP, or
in response to receiving second configuration information transmitted by the network-side device, determining the first search space in the second BWP.

21. (canceled)

22. The method of claim 19, wherein the determining, based on the predefined rule, the first search space in one of the first BWP or the second BWP comprises:
determining the first search space in the second BWP; or
determining a target BWP in which a search space for monitored paging signaling is located, and
determining the first search space in the target BWP.

23. (canceled)

24. The method of claim 22, further comprising:
determining, based on a broadcast message transmitted by the network-side device, the second BWP, and
wherein the broadcast message comprises at least one of system information or paging signaling.

25. (canceled)

26. The method of claim 22, wherein the determining the first search space in the second BWP comprises:
switching from the first BWP to the second BWP at a preset time, and
monitoring the first search space in the second BWP.

27. The method of claim 22, further comprising:
switching from the second BWP to the first BWP within a preset duration after monitoring the first search space in the second BWP.

28. The method of claim 22, wherein a duration between a first time domain resource corresponding to the PEI in the first search space and a second time domain resource corresponding to the paging message to be monitored is greater than a preset number of time domain units.

29-30. (canceled)

31. A communication device, comprising:
a processor; and
a memory communicatively coupled to the processor and configured to store at least one computer program,
wherein the at least one computer program, when executed by the processor, cause the processor to:
configure a first search space, for a paging early indication (PEI) of a first type of terminal, in one of a first bandwidth part (BWP) or a second BWP.

32. A communication device, comprising:
a processor; and
a memory communicatively coupled to the processor and configured to store at least one computer program, and
wherein the at least one computer program, when executed by the processor, cause the processor to perform the method for determining search space according to claim 15.

33-34. (canceled)
